(19) United States
(12) Patent Application Publication
(10) Pub. No.: US 2009/0178242 A1
(43) Pub. Date: Jul. 16, 2009

(54) Hinge assembly

(75) Inventor: Pen-Kun Lin, Shulin City (TW)

Correspondence Address: BACON & THOMAS, PLLC, 625 SLATERS LANE, FOURTH FLOOR, ALEXANDRIA, VA, 22314-1176, US

(73) Assignee: SHIN ZU SHING CO., LTD, Shulin City (TW)

(21) Appl. No.: 12/007,618

(22) Filed: Jan. 14, 2008

(51) Int. Cl. E05D 11/08; E05D 7/00; G06F 1/16

(52) U.S. Cl. 16/341

(57) ABSTRACT

A hinge assembly connects a cover to a base and further has a pressing member. The pressing member has a stationary pressing spacer and a rotating pressing spacer. Each of the pressing spacers has at least one inclined protrusion formed on an abutting surface. The inclined protrusions of the pressing spacers correspond to each other. When the cover is opening until an upper edge of one inclined protrusion corresponds to a lower edge of another inclined protrusion, people may open the cover lightly and fast. Alternative, when the cover is closing until the upper edges of the inclined protrusions and the lower edges of the inclined protrusions respectively correspond to each other, people may close the cover heavily and slowly to prevent the base from being stricken by the cover.

### BACKGROUND OF THE INVENTION

1. Field of the Invention

The present invention relates to a hinge assembly, and more particularly to a hinge assembly that connects a cover to a base and allows the cover to open lightly and close heavily.

2. Description of the Prior Arts

Electronic devices such as laptops, mobile phones, personal digital assistants (PDA), etc. have a base, a cover and a hinge. The hinge connects the cover to the base to allow the cover to pivot relative to the base and to reduce a volume of the electronic device.

When people open the cover relative to the base, they might expect that the cover could be opened lightly and fast to allow the electronic device being used as quickly as possible. Additionally, when people close the cover relative to the base, they might expect that the cover could be closed heavily and slowly to prevent the base from being stricken by the cover.

However, no matter the cover is opened or closed, the conventional hinge provides the same friction. Therefore a balance is struck between low resistance and easy to open but not preventing damage and high resistance, preventing damage but hard to open.

To overcome the shortcomings, the present invention provides a hinge assembly to mitigate or obviate the aforementioned problems.

### SUMMARY OF THE INVENTION

The main objective of the present invention is to provide a hinge assembly that connects a cover to a base and further has a pressing member. The pressing member has a stationary pressing spacer and a rotating pressing spacer. Each of the pressing spacers has at least one inclined protrusion formed on an abutting surface. The inclined protrusions of the pressing spacers correspond to each other.

When the cover is opening until an upper edge of one inclined protrusion corresponds to a lower edge of another inclined protrusion, people may open the cover lightly and fast. Alternative, when the cover is closing until the upper edges of the inclined protrusions and the lower edges of the inclined protrusions respectively correspond to each other, people may close the cover heavily and slowly to prevent the base from being stricken by the cover.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge assembly in accordance with the present invention;

FIG. 2 is an exploded view of the hinge assembly in FIG. 1;

FIG. 3 is an enlarged exploded perspective view of a pressing member of the hinge assembly in FIG. 1;

FIG. 4 is an enlarged perspective view of a rotating pressing spacer of the hinge assembly in FIG. 1;

FIG. 5 is an enlarged exploded perspective view of a positioning member of the hinge assembly in FIG. 1;

FIG. 6 is an operational side view of the hinge assembly in FIG. 1, shown being closed;

FIG. 7 is another operational side view of the hinge assembly in FIG. 1, shown being opening;

FIG. 8 is still another operational side view of the hinge assembly in FIG. 1, shown being open; and

FIG. 9 is an operational side view of the hinge assembly in FIG. 1, shown mounted in an electronic device.

### DETAILED DESCRIPTION OF THE PREFERRED EMBODIMENTS

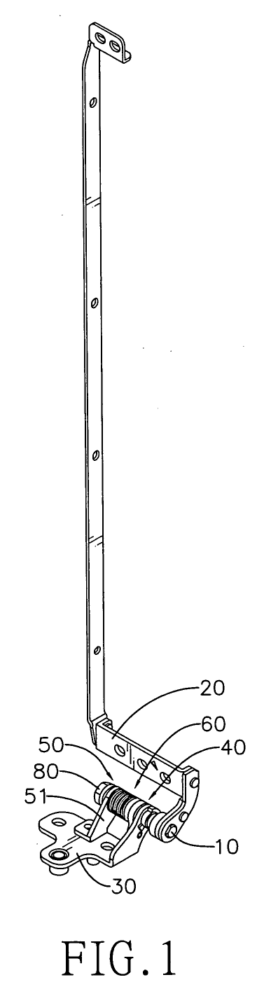

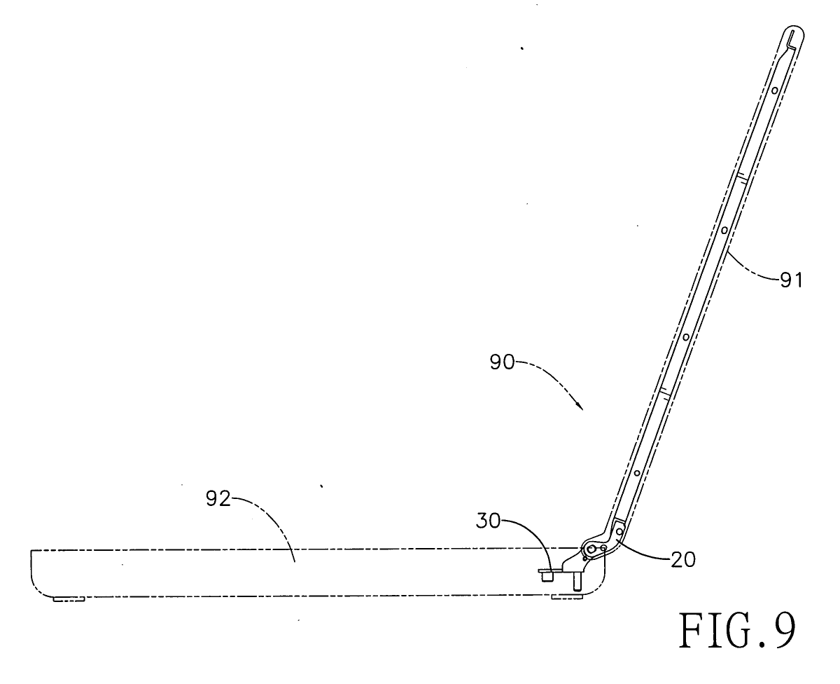

With reference to FIGS. 1 and 9, a hinge assembly in accordance with the present invention is mounted in an electronic device (90) having a cover (91) and a base (92), comprises a shaft (10), a rotating bracket (20), a stationary bracket (30), an optional positioning member (40), a pressing member (50), multiple resilient rings (60), multiple washers (70) and a fastener (80).

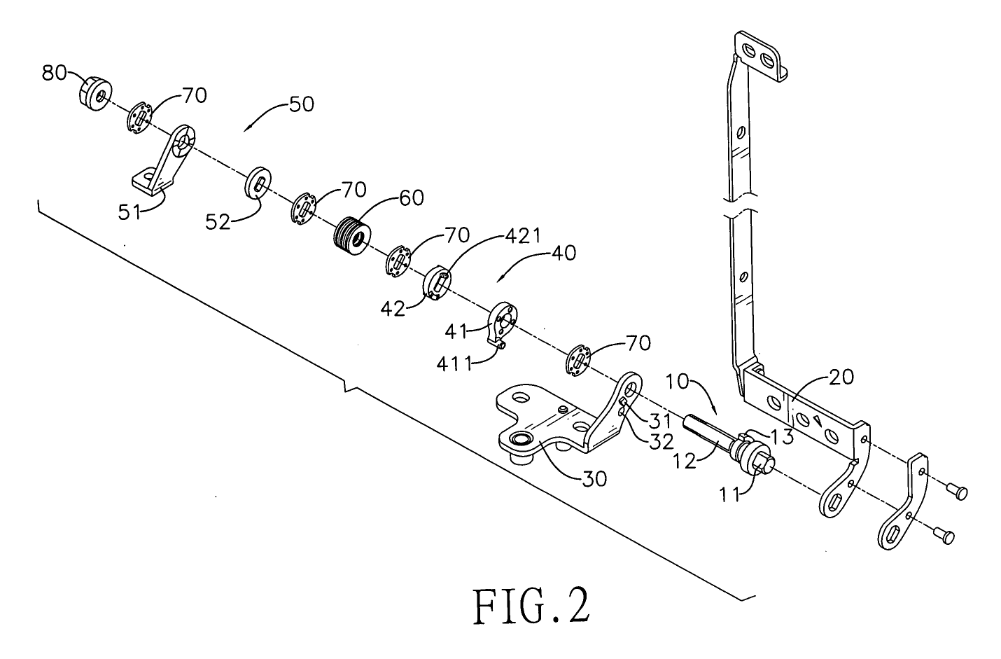

With further reference to FIG. 2, the shaft (10) has a fastening rod (11) and an extension rod (12) and may have a stop (13). The fastening rod (11) is non-circular in cross-section and has a proximal end and a distal end. The extension rod (12) is non-circular in cross-section, is formed concentrically on the proximal end of the fastening rod (11), has a distal end and may have an external thread. The external thread is formed around the extension rod (12) near the distal end. The stop (13) is formed radially between the fastening rod (11) and the extension rod (12).

The rotating bracket (20) connects to the cover (91) of the electronic device (90) and is mounted securely around the distal end of the fastening rod (11).

The stationary bracket (30) connects to the base (92) of the electronic device (90), is mounted rotatably around the extension rod (12), may be adjacent to the stop (13), has an outer surfaces and may have a limiting protrusion (31) and a positioning hole (32). The limiting protrusion (31) is formed on the outer surface of the stationary bracket (30) and selectively abuts the stop (13) of the shaft (10) to limit the rotating angle of the rotating bracket (20) and the shaft (10) relative to the stationary bracket (30). The fastening hole (32) is formed through the stationary bracket (30).

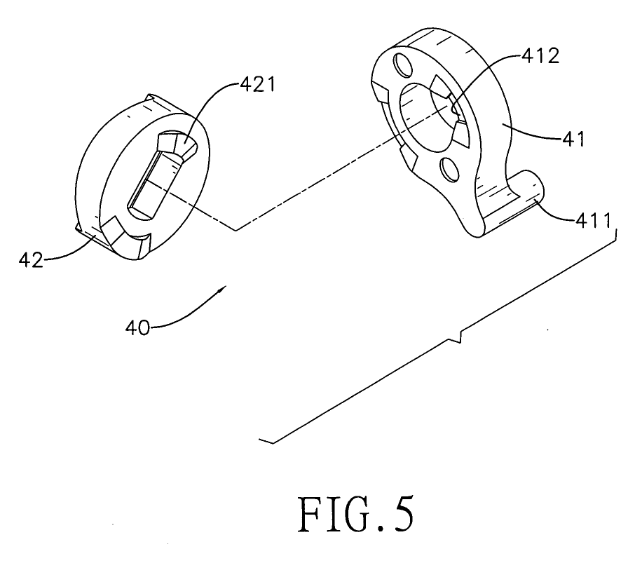

With further reference to FIG. 5, the positioning member (40) is mounted around the extension rod (12) and has a stationary positioning spacer (41) and a rotating positioning spacer (42).

The stationary positioning spacer (41) is mounted around the extension rod (12), has an inner surface, an outer surface, an optional fastening protrusion (411) and multiple positioning detents (412). The fastening protrusion (411) is formed on the inner surface of the stationary positioning spacer (41) and is mounted securely in the fastening hole (32) of the stationary bracket (30). The positioning detents (412) are formed separately on the outer surface of the stationary positioning spacer (41).

The rotating positioning spacer (42) is mounted securely around the extension rod (12) adjacent to the outer surface of the stationary positioning spacer (41) and has an inner surface and multiple positioning protrusions (421). The positioning protrusions (421) are formed separately on the inner surface of the rotating positioning spacer (42) and respectively correspond to and selectively engage the positioning detents (412) of the stationary positioning spacer (41).

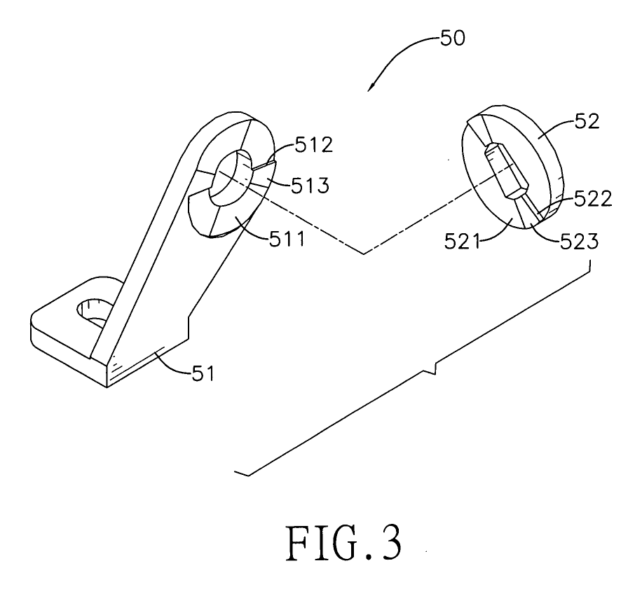

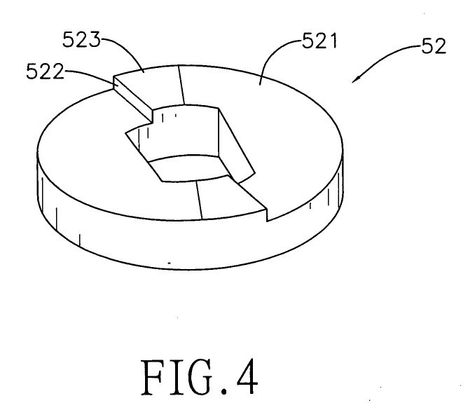

With further reference to FIGS. 3 and 4, the pressing member (50) is mounted around the extension rod (12), provides an increasing or decreasing frictional force and has a stationary pressing spacer (51) and a rotating pressing spacer (52).

The stationary pressing spacer (51) is mounted around the extension rod (12), is attached securely to the stationary bracket (30) and has an abutting surface, a central hole and at least one inclined protrusion (511). The central hole is formed through the stationary pressing spacer (51) and is mounted around the extension rod (12). The at least one inclined protrusion (511) is formed on the abutting surface and around the central hole of the stationary pressing spacer (51). Each one of the at least one inclined protrusion (511) has a lower edge, an upper edge and a step (512) and may have a flat (513). The upper edge is thicker than the lower edge. The step (512) is formed between the upper edge of the inclined protrusion (511) and the abutting surface of the stationary pressing spacer (51). The flat (513) is formed on the inclined protrusion (511) adjacent to the upper edge.

The rotating pressing spacer (52) is mounted securely around the extension rod (12) adjacent to the abutting surface of the stationary pressing spacer (51) and has an abutting surface, a central hole and at least one inclined protrusion (521). The abutting surface corresponds to the abutting surface of the stationary pressing spacer (51). The central hole is formed through the rotating pressing spacer (52), is non-circular in cross-section and is mounted securely around the extension rod (12). The at least one inclined protrusion (521) is formed in the abutting surface and around the central hole of the rotating pressing spacer (52). Each one of the at least one inclined protrusion (521) selectively abuts a corresponding inclined protrusion (511) of the stationary pressing spacer (51) and has a lower edge, an upper edge and a step (522) and may have a flat (523). The upper edge is thicker than the lower edge. The step (522) is formed between the upper edge of the inclined protrusion (521) and the abutting surface of the rotating pressing spacer (52) and selectively abuts the step (512) of the corresponding inclined protrusion (511) of the stationary pressing spacer (51). The flat (523) is formed on the inclined protrusion (521) adjacent to the upper edge and selectively abuts the flat (513) of the corresponding inclined protrusion (511) of the stationary pressing spacer (51).

The resilient rings (60) are mounted around the extension rod (12) between the stationary bracket (30) and the rotating pressing spacer (52) and may be mounted between the rotating positioning spacer (42) and the rotating pressing spacer (52) to press the positioning member (40) and pressing member (50) firmly abuts to each other.

The washers (70) are mounted securely around the extension rod (12) and are respectively mounted adjacent to the stationary pressing spacer (51) and rotating pressing spacer (52) of the pressing member (50) and may adjacent to the stationary positioning spacer (41) and the rotating positioning spacer (42) of the positioning member (40).

The fasteners (80) is mounted securely on the distal end of the extension rod (12), has an inner surface and may have an internal thread. The internal thread is formed around the inner surface of the fastener (80) and is screwed onto the external thread of the extension rod (12) of the shaft (10).

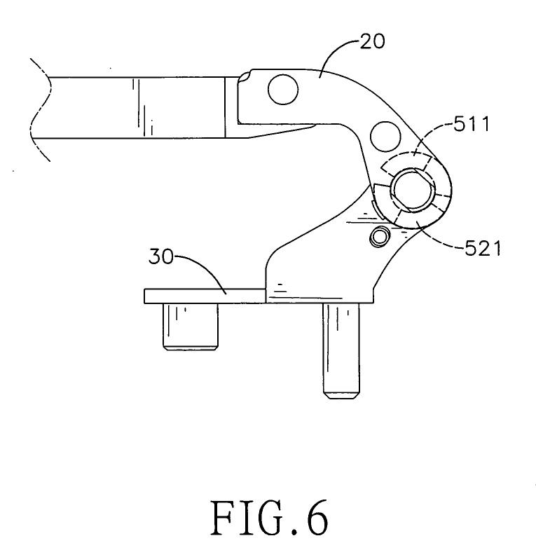

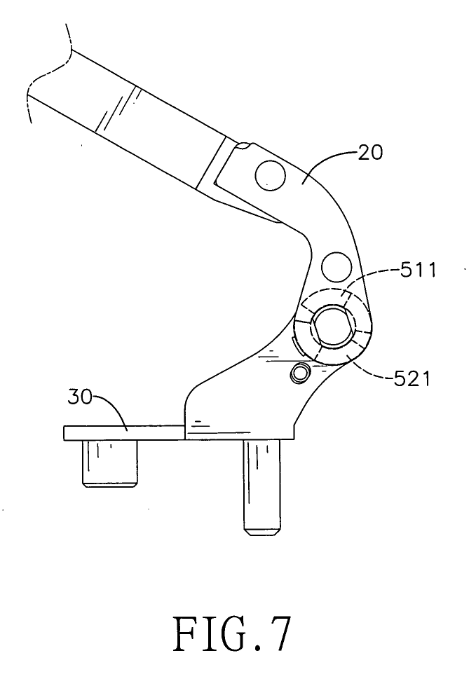

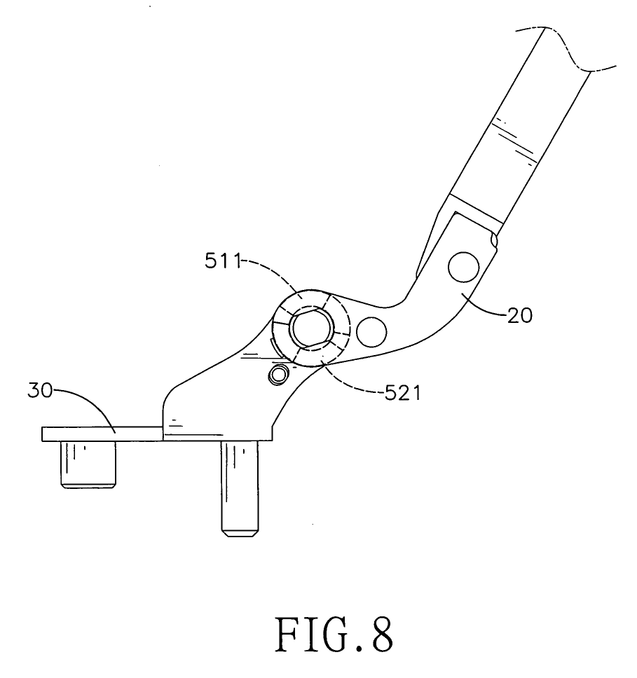

With further reference to FIGS. 6, 7 and 8, the hinge assembly as described has the following advantages. When the cover (91) is opened relative to the base (92), the inclined protrusion (521) of the rotating pressing spacer (52) moves along the inclined protrusion (511) of the stationary pressing spacer (51) until the upper edge of one inclined protrusion (51, 52) corresponds to the lower edge of another inclined protrusion (51, 52). Therefore, the resilient rings (60) are gradually released to cause that frictional force between the resilient rings (60) decreases and people may open the cover (91) lightly and fast. Alternative, when the cover (91) is closed relative to the base (92) until the upper edges of the inclined protrusions (511, 521) of the pressing spacers (51, 52) correspond to each other and the lower edges of the inclined protrusions (511, 521) of the pressing spacers (51, 52) correspond to each other. Therefore, the pressing member (50) presses the resilient rings (60) to cause that the frictional force between the resilient rings (60) increases and people may close the cover (91) heavily and slowly to prevent the base (92) from being stricken by the cover (91).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge assembly comprising
a shaft having
a fastening rod being non-circular in cross-section and having
a proximal end; and
a distal end; and
an extension rod being non-circular in cross-section, being formed concentrically on the proximal end of the fastening rod and having a distal end;
a rotating bracket being mounted securely around the distal end of the fastening rod;
a stationary bracket being mounted rotatably around the extension rod and having and outer surface;
a pressing member being mounted around the extension rod and having
a stationary pressing spacer being mounted around the extension rod, being attached securely to the stationary bracket and having
an abutting surface;
a central hole being formed through the stationary pressing spacer and being mounted around the extension rod; and
at least one inclined protrusion being formed on the abutting surface and around the central hole of the stationary pressing spacer and each one of the at least one inclined protrusion having
a lower edge;
an upper edge being thicker than the lower edge; and
a step being formed between the upper edge of the inclined protrusion and the abutting surface of the stationary pressing spacer; and
a rotating pressing spacer being mounted securely around the extension rod adjacent to the abutting surface of the stationary pressing spacer and having
an abutting surface corresponding to the abutting surface of the stationary pressing spacer;
a central hole being formed through the rotating pressing spacer, being non-circular in cross-section and being mounted securely around the extension rod; and
at least one inclined protrusion being formed in the abutting surface and around the central hole of the rotating pressing spacer of the stationary pressing spacer and each one of the at least one inclined protrusion selectively abutting a corresponding inclined protrusion and having
a lower edge;
an upper edge being thicker than the lower edge; and
a step being formed between the upper edge of the inclined protrusion and the abutting surface of the rotating pressing spacer and selectively abutting the step of the corresponding inclined protrusion of the stationary pressing spacer;
multiple resilient rings being mounted around the extension rod between the stationary bracket and the rotating pressing spacer;
multiple washers being mounted securely around the extension rod and being respectively mounted adjacent to the stationary pressing spacer and rotating pressing spacer of the pressing member; and
a fastener being mounted securely on the distal end of the extension rod and having an inner surface.

2. The hinge assembly as claimed in claim 1, wherein
each one of the at least one inclined protrusion of the stationary pressing spacer of the pressing member further has a flat being formed on the inclined protrusion adjacent to the upper edge; and
each one of the at least one inclined protrusion of the rotating pressing spacer of the pressing member further has a flat being formed on the inclined protrusion adjacent to the upper edge and selectively abutting the flat of the corresponding inclined protrusion of the stationary pressing spacer.

3. The hinge assembly as claimed in claim 1, wherein
the hinge assembly further has a positioning member being mounted around the extension rod and having
a stationary positioning spacer being mounted around the extension rod and having
an inner surface;
an outer surface; and
multiple positioning detents being formed separately on the outer surface of the stationary positioning spacer;
a rotating positioning spacer being mounted securely around the extension rod adjacent to the outer surface of the stationary positioning spacer and having
an inner surface; and
multiple positioning protrusions being formed separately on the inner surface of the rotating positioning spacer and respectively corresponding to and selectively engaging the positioning detents of the stationary positioning spacer;
the resilient rings are mounted between the rotating positioning spacer and the rotating pressing spacer; and
the washers are further respectively mounted adjacent to the stationary positioning spacer and the rotating positioning spacer of the positioning member.

4. The hinge assembly as claimed in claim 2, wherein
the hinge assembly further has a positioning member being mounted around the extension rod and having
a stationary positioning spacer being mounted around the extension rod and having
an inner surface;
an outer surface; and
multiple positioning detents being formed separately on the outer surface of the stationary positioning spacer;
a rotating positioning spacer being mounted securely around the extension rod adjacent to the outer surface of the stationary positioning spacer and having
an inner surface; and
multiple positioning protrusions being formed separately on the inner surface of the rotating positioning spacer and respectively corresponding to and selectively engaging the positioning detents of the stationary positioning spacer;
the resilient rings are mounted between the rotating positioning spacer and the rotating pressing spacer; and
the washers are further respectively mounted adjacent to the stationary positioning spacer and the rotating positioning spacer of the positioning member.

5. The hinge assembly as claimed in claim 3, wherein
the stationary bracket further has a fastening hole being formed through the stationary bracket; and
the stationary positioning spacer of the positioning member further has a fastening protrusion being formed on the inner surface of the stationary positioning spacer and being mounted securely in the fastening hole of the stationary bracket.

6. The hinge assembly as claimed in claim 4, wherein
the stationary bracket further has a fastening hole being formed through the stationary bracket; and
the stationary positioning spacer of the positioning member further has a fastening protrusion being formed on the inner surface of the stationary positioning spacer and being mounted securely in the fastening hole of the stationary bracket.

7. The hinge assembly as claimed in claim 5, wherein
the shaft further has a stop being formed radially between the fastening rod and the extension rod; and
the stationary bracket is adjacent to the stop and further has a limiting protrusion being formed on the outer surface of the stationary bracket and selectively abutting the stop of the shaft.

8. The hinge assembly as claimed in claim 6, wherein
the shaft further has a stop being formed radially between the fastening rod and the extension rod; and
the stationary bracket is adjacent to the stop and further has a limiting protrusion being formed on the outer surface of the stationary bracket and selectively abutting the stop of the shaft.

9. The hinge assembly as claimed in claim 7, wherein
the extension rod of the shaft further has an external thread being formed around the extension rod near the distal end; and
the fastener further has an internal thread being formed around the inner surface of the fastener and being screwed onto the external thread of the extension rod of the shaft.

10. The hinge assembly as claimed in claim 8, wherein
the extension rod of the shaft further has an external thread being formed around the extension rod near the distal end; and
the fastener further has an internal thread being formed around the inner surface of the fastener and being screwed onto the external thread of the extension rod of the shaft.
